(19) United States
(12) Patent Application Publication
(10) Pub. No.: US 2004/0026318 A1
(43) Pub. Date: Feb. 12, 2004

(54) Method for fractionating essential oils using at least a fluorinated solvent

(76) Inventors: Benoit Lemaire, Sarzeau (FR); Bernard Mompon, Vannes (FR); Isabelle Surbled, Saint-Nolff (FR); Michel Surbled, Saint-Nolff (FR)

Correspondence Address: Westman Champlin & Kelly, 900 Second Avenue South, Suite 1600 - International Centre, Minneapolis, MN, 55402-3319, US

(21) Appl. No.: 10/312,223

(22) PCT Filed: Jun. 22, 2001
(86) PCT No.: PCT/FR01/01990

(30) Foreign Application Priority Data
Jun. 22, 2000 (FR) FR00 08045

(51) Int. Cl. B01D 11/00

(52) U.S. Cl. 210/634; 210/639; 210/806; 210/774; 426/425

(57) ABSTRACT

The invention concerns a method for fractinating essential oils or essential oil fractions, characterised in that it comprises a step which consists in contacting said essential oils with an extracting agent containing at least a fluorinated solvent so as to obtain a fluorinated phase and a non-fluorinated phase and a step which consists in separating the essential oils contained in said fluorinated phase and in said non-fluorinated phase.

The invention relates to the field for obtaining essential oils. More specifically, the invention relates to the extraction and fractionation of essential oils originating from plants.

The invention notably finds its application in the fields of cosmetics, pharmaceuticals and foodstuffs.

Essential oils are conventionally produced by stripping with steam, by hydrodistillation or any other alternative method of the above. Citrus essential oils are an exception as they may also be produced by pressing fruit rinds.

Constituents of essential oils may be classified according to their level of functionalization and according to the nature of the chemical function which they bear. Non-functionalized hydrocarbons which more often are monoterpenic hydrocarbons, and sesquiterpenic hydrocarbons are thus distinguished. The most current chemical functions which substitute the hydrocarbon backbones of the constituents of essential oils are:

the aldehyde function (for example: citral, benzaldehyde)

the ketone function (for example: pulegone, carvone)

the ester or lactone function (for example: lynalyl acetate, tridecanolide)

the ester function (for example, eucalyptol, anethol)

the hydroxyl function (for example, citronellol, menthol), termed as phenolic when it substitutes an aromatic hydrocarbon unit (for example: thymol, eugenol).

Essential oils often need to be fractionated, i.e., the different fractions which make them up, need to be separated.

Thus, certain applications require particular properties of essential oils. For example, it may be a question of increasing the aromatic strength of the essential oil. In this case, the essential oil undergoes a deterpenation operation consisting of separating the terpenic hydrocarbons and the functionalized compounds, the aromatic notes of which are more interesting. It may also be a question of removing various, harmful or toxic constituents. For example thujone, is a neurotoxic substance present in various essential oils used for food or aromatherapic purposes for example. Psoralenes are photosensitive compounds present in the essential oils of most citrus fruits, and more particularly in bergamot essential oil. These compounds must absolutely be removed before incorporating essential oil in cosmetic compositions.

The most currently used methods for fractionating essential oils are distillation, adsorption-desorption, or treatment with supercritical CO₂.

One of the disadvantages of distillation, is that it submits the most labile constituents to sufficiently high temperatures leading to degradation reactions. In the case of adsorption-desorption, the main disadvantages are the use of organic solvents, the low productivity, and the cost of the method.

Organic solvents are additionally concerned by various regulations. As an example, regulations relative to emission of volatile organic compounds (VOC) will also be retained, which may lead to important constraints for industrialists in the short term.

These regulatory constraints originate from the harmful or toxic character of the organic solvents used. This harmfulness and this toxicity appear at generally low levels of residual solvents in the obtained extracts. To suppress any health risks, desolventization methods which have several drawbacks, need to be implemented consequently. Indeed, besides the resulting overcast, these desolventization methods may, according to the applied operating conditions, have a negative incidence on the quality of the produced extracts.

Treatments with supercritical CO₂ provide the double advantage of being a fractionation method without any organic solvent, and of submitting the load to lower temperatures than those imposed by distillation. On the other hand, it requires specific equipment which represent heavy investments.

The main object of the present invention is to provide a method for fractionating essential oils, which does not have the drawbacks of the methods from the state of the art.

This object is achieved through the invention which relates to a method for fractionating essential oils or fractions of essential oils, characterized in that it comprises a step of contacting said essential oils with an extracting agent containing at least a fluorinated solvent in order to obtain a fluorinated phase and a non-fluorinated phase and a step for separating the essential oil fractions contained in said fluorinated phase and in said non-fluorinated phase.

According to the implemented raw material, the applied operating conditions and the fluorinated solvents used, it is possible with the described method to meet the technical requirements of various treatments applied to essential oils or fractions of essential oils, both at the scale of the laboratory, and at the industrial production scale. The deterpenation of essential oils or the removal of certain harmful or toxic compounds is notably found among the applications of the provided method.

According to the invention, these fluorinated solvents may preferentially be:

aliphatic perfluoroalkanes characterized by the general formula CₙF₂ₙ₊₂ (5≦n≦15)

perfluoroalkanes having a cyclic unit and characterized by the general formula CₙF₂ₙ (5≦n≦15)

perfluoroalkanes having two cyclic units and characterized by the general formula CₙF₂ₙ₋₂ (8≦n≦15)

perfluoro-N-methylmorpholine of general formula C₅ONF₁₁

hydrofluoroethers (HFE) characterized by the general formula CₙF₂ₙ₊₁OCₘH₂ₘ₊₁ wherein 3≦n≦8 and 1≦m≦6.

Perfluorinated solvents more particularly concerned by the present invention are perfluoro-N-methylmorpholine (also known commercially under the designation PF5052), n-perfluoropentane (PF5050), n-perfluorohexane (PF5060)n n-perfluoroheptane (PF5070) and n-perfluorooctane (PF5080) as well as their isomers. Hydrofluoroethers more particularly concerned by the present invention are methoxynonafluorobutane (C₄F₉—O—CH₃), also called HFE7100, and ethoxynona-fluorobutane (C₄F₉—O—C₂H₅), also called HFE7200, as well as isomers thereof.

As compared with conventional extraction solvents, the aforementioned fluorinated solvents have many advantages:

they are uninflammable and therefore do not impose the use of special production and protection equipment. This feature is particularly interesting in the prospect of production at an industrial scale as this has a direct incidence on the cost of the finish products;

they do not represent a risk for the environment and they comply with the strictest environmental regulations. They are not registered in the list of volatile organic compounds (VOC), their potential of destruction of the ozone layer is nil and their contribution to the greenhouse effect is very low;

they are chemically inert, odorless, colorless and tasteless. Therefore, they have no negative incidence on the properties of extracts or formulations which contain them or for the preparation of which they were used;

even at high dosages, they are non-toxic by repeated inhalation, adsorption, or contact. Moreover, advantage was taken of this lack of toxicity for incorporating HFEs into cosmetic formulae (Patent Applications WO 99/26594 and WO 99/26600);

they have a low heat capacity and a low latent heath of vaporization as compared with those of organic solvents currently used in extractions. The energy costs for implementing or retreating them are therefore notably alleviated;

they have high vapor pressures which facilitate desolventization of the extracts.

Another advantage lies in their exceptional selectivity, particularly in the case of perfluorinated solvents. The applicant has indeed noticed that they solubilize hydrocarbons, preferentially over functionalized derivatives. Among the functionalized derivatives, it has also been observed that derivatives with aprotic functions (ether, ester, ketone, aldehyde are generally solubilized preferentially over derivatives with protic functions (alcohols, phenols), and that among the derivatives with free hydroxyl functions, alcohols are solubilized preferably over phenols. It has further been observed that among hydrocarbons, monoterpenes are solubilized preferentially over sesquiterpenes.

According to the invention, by contacting an essential oil and an extracting agent containing at least one fluorinated solvent, it is thus possible to obtain two phases, the compositions of which will notably depend on the treated essential oil, the fluorinated solvent used, and the treatment temperature.

As a rule, the phase containing the fluorinated solvent is mainly enriched in monoterpenic hydrocarbons, and to a lesser degree, in sesquiterpenic hydrocarbons. Also, as a rule, the phase which is not solubilized by the fluorinated solvent (non fluorinated phase) is mainly enriched in functionalized constituents with protic functions (alcohols, phenols) and to a lesser degree, in functionalized compounds with aprotic functions (esters, ethers, aldehydes, ketones . . . ).

The constituents of the fluorinated phase may be recovered by evaporating the extracting agent, preferably under reduced pressure in order to reduce the treatment temperature. The non-fluorinated phase which only contains a small amount of extracting agent, may be treated in the same way. If necessary, the non-fluorinated phase may be cooled in order to cause demixing or precipitation of the less soluble constituents. The latter may also be recovered and desolventized easily. If necessary, the fluorinated phase may also be treated with cooling as mentioned above.

It shall be noted that fractionation may be carried out in a batch mode, a semi-continuous mode, or in a continuous mode. If the solubility of hydrocarbons in a given fluorinated solvent is estimated as being too low, the semi-continuous mode will be preferred. It will for example, have the advantage of meeting the productivity requirements when implementing the method in an industrial framework.

In the case of an implementation in a semi-continuous mode, the essential oil is maintained in an enclosure, the temperature of which is set to a value considered as optimal for the extraction. The fluorinated solvent distributed as droplets, crosses the essential oil layer from the bottom to the top of it under the effect of the density difference of both liquid phases. The fluorinated phase loaded with extract, is collected at the bottom of the extraction stage, and is then directed towards a stage for separating the extracting agent and the extracted constituent by distillation. The thereby re-generated extracting agent is recycled towards the extraction stage.

According to the needs, different improvements may be made to the method. In particular, it is possible to inertize the extracting agent beforehand by submitting it to any degassing method. (bubbling with an inert gas, reflux boiling, sonication, degassing on membranes . . . ) This inertization operation reduces the dissolved oxygen content, ordinarily high in fluorinated solvents, and thereby limits the risks of degradation of the more oxidizable compounds, such as aldehydes. An inert, static or dynamic atmosphere may also be maintained in the extraction enclosure during the fractionation operation.

If the extraction temperature needs to be maintained at an exact optimal value, the temperature of the extracting agent from the recycling stage may then be brought to the same value, by having the extracting agent pass into a heat exchanger before its distribution in the load to be treated.

In order to increase the extracting agent flow rates, or to reduce the boiling temperature of the extract in the recycling stage, the method may be implemented at a lower pressure than the atmospheric pressure. The condenser of the recycling stage then needs to be provided with a cooling system with sufficient power for limiting the extracting agent losses.

In order to adjust the required selectivity for the fractionation to be carried out, a co-solvent comprising at least an organic solvent, may be added to the fluorinated extracting agent. However, an extracting agent exclusively made up of fluorinated solvents is preferably used for the aforementioned advantages.

The examples described below illustrate a few possible applications of the present invention. They relate to essential oils of clove bud, bergamot, and origan. These examples are non-limiting. Fractionation of essential oils with fluorinated solvents may actually be applied to many other essential oils, for uses notably in cosmetics, pharmaceutical or foodstuffs.

### EXAMPLE 1

### Fractionation of Clove Bud Essential Oil

This example is intended for quantitating the partition coefficient of the main tracers of clove bud essential oil between a fluorinated solvent and the actual essential oil. The tested fluorinated solvents are perchlorohexane (PF5060), perfluorooctane (PF5080), and perfluoro-N-methylmorpholine (PF5052). Clove bud essential oil was selected because of its richness in eugenol, a compound comprising a free phenolic hydroxyl and a phenolic hydroxyl engaged in an ether bond.

The fractionation of 100 g of essential oil is carried out with 100 g of fluorinated solvent. The mixture is stirred for 20 minutes at 25° C. After decantation, both liquid phases are volumed and analyzed by gas chromatography.

Table 1 below specifies for each tested fluorinated solvent:

the initial volume of essential oil (Vi HE)

the initial volume of fluorinated solvent (Vi SF)

the volume of supernatant essential oil at equilibrium (Veq HE)

the volume of the fluorinated phase at equilibrium (Veq SF)

TABLE 1

| | PF5060 | PF5080 | PF5052 |
|---|---|---|---|
| Vi HE (ml) | 93.5 | | |
| Vi SF (ml) | 59.5 | 56.8 | 58.8 |
| Veq HE (ml) | 94.0 | 93.2 | 94.0 |
| Veq SF (ml) | 58.0 | 57.8 | 56.6 |

Table 2 below specifies for each tested fluorinated solvent, the partition coefficient (K_{eq}) between both phases at equilibrium, of the main tracers of the essential oil; K is defined as the ratio of the concentrations of each tracer in the fluorinated phase and in the supernatant essential oil when the biphasic system is at equilibrium. The table additionally specifies for each tracer, its initial content in the essential oil (Cᵢ) as well as its chemical family to which it belongs or its functionalization.

TABLE 2

| | | Ci | | | |
|---|---|---|---|---|---|
| | Chemical family/ | (% | K_{eq} (×10³) | | |
| | functionalization | m/m) | PF5060 | PF5080 | PF5052 |
| Eugenol | Phenol (2 phenolic | 79 | 5 | | 6 |
| | OH groups with 1 | | | | |
| | etherified group) | | | | |
| β- | Sesquiterpene | 13 | 32 | 37 | 51 |
| caryophyllene | | | | | |
| Acetyleugenol | Phenol (2 blocked | 5 | ND | ND | ND |
| | phenolic OH groups) | | | | |
| α-humulene | Sesquiterpene | 1 | ND | ND | ND |

ND: not detected in the fluorinated phase by gas chromatography

These results show that the fluorinated solvents used are selective and that they solubilize the hydrocarbon species preferentially over phenols with free or blocked hydroxyl functions. The fact that humulene is not detected in the fluorinated phase, is due to its low initial content in the essential oil on the one hand, and on the other hand to another aspect of the selectivity of the fluorinated solvents, which appears between monoterpenic and sesquiterpenic hydrocarbons.

### EXAMPLE 2

### Fractionation of Bergamot Essential Oil

This example is intended for quantitating the partition coefficient of the main tracers of bergamot essential oil between a fluorinated solvent and the actual essential oil. The tested fluorinated solvents are perchlorohexane (PF5060), perfluorooctane (PF5080), and perfluoro-N-methylmorpholine (PF5052). Bergamot essential oil was selected for the following reasons:

its richness in linalol, a compound comprising a non phenolic hydroxyl

its high content in psoralenes (photosensitive compounds of the coumarin family)

the presence of flavonoids because of the production mode by pressing the essential oil; these flavonoids are strongly functionalized and bear phenolic functions, some of which may be glycosylated, esterified or etherified.

Fractionation of 100 g of essential oil is carried out with 100 g of fluorinated solvent. The mixture is stirred for 20 minutes at 25° C. After decantation, both liquids phases are volumed and analyzed by gas chromatography.

Table 3 below specifies for each tested fluorinated solvent

the initial volume of essential oil (Vi HE)

the initial volume of fluorinated solvent (Vi SF)

the volume of supernatant essential oil at equilibrium (Veq HE)

the volume of the fluorinated phase at equilibrium (Veq SF)

TABLE 3

| | PF5060 | PF5080 | PF5052 |
|---|---|---|---|
| Vi HE (ml) | 112.4 | | |
| Vi SF (ml) | 59.5 | 56.8 | 58.8 |
| Veq HE (ml) | 108.6 | 110.0 | 113.2 |
| Veq SF (ml) | 58.0 | 56.6 | 56.8 |

Table 4 below specifies, for each tested fluorinated solvent, the partition coefficient (K_{eq}) between both phases at equilibrium, of the main tracers of the essential oil; K is defined as the ratio of the concentrations of each tracer in the fluorinated phase and in the supernatant essential oil when the biphasic system is at equilibrium. The table additionally specifies for each tracer, its initial content in the essential oil (Cᵢ) as well as its chemical family to which it belongs, or its functionalization.

TABLE 4

| | | Ci | | | |
|---|---|---|---|---|---|
| | Chemical family/ | (% | K_{eq} (×10³) | | |
| | functionalization | m/m) | PF5060 | PF5080 | PF5052 |
| α-pinene | monoterpene | 1 | 80 | 79 | 107 |
| p-cymene | | 1 | 43 | 42 | 58 |
| β-pinene | | 5 | 63 | 62 | 89 |
| γ- | | 5 | 41 | 40 | 58 |
| terpinene | | | | | |
| limonene | | 30 | 46 | 45 | 65 |
| lynalyl | monoterpenic | 30 | 22 | 20 | 32 |
| acetate | alcohol with an | | | | |
| | esterified OH | | | | |
| | function | | | | |
| linalol | monoterpenic | 14 | ND | ND | ND |
| | alcohol | | | | |

ND: not detected in the fluorinated phase by gas chromatography

These results show that the fluorinated solvents used are selective and that they solubilize hydrocarbon species preferentially over species with free non-phenolic hydroxyls. In particular, it will be noted that linolol is not detected in spite of a content which is however not insignificant, in the essential oil (14%). On the other hand, selectivity with regards to lynalyl acetate is less marked than in the case of linalol, and it expresses the less polar character of the esters. However, it shall be noted that the partition coefficient of lynalyl acetate significantly remains lower than those for terpenic hydrocarbons.

### EXAMPLE 3

### Fractionation of Origan Essential Oil

This example is intended for quantitating the partition coefficient of the main tracers of origan essential oil between a fluorinated solvent and the actual essential oil. The tested fluorinated solvents are perchlorohexane (PF5060), perfluorooctane (PF5080), and perfluoro-N-methylmorpholine (PF5052). Origan essential oil was selected for its high content in carvacrol, a compound comprising a free phenolic hydroxyl.

Fractionation of 100 g of essential oil is carried out with 100 g of fluorinated solvent. The mixture is stirred for 20 minutes at 25° C. After decantation, both liquids phases are volumed and analyzed by gas chromatography.

Table 5 below specifies for each tested fluorinated solvent:

the initial volume of essential oil (Vi HE)

the initial volume of fluorinated solvent (Vi SF)

the volume of supernatant essential oil at equilibrium (Veq HE)

the volume of the fluorinated phase at equilibrium (Veq SF)

TABLE 5

| | PF5060 | PF5080 | PF5052 |
|---|---|---|---|
| Vi HE (ml) | 106.4 | | |
| Vi SF (ml) | 59.5 | 56.8 | 58.8 |
| Veq HE (ml) | 104.6 | 102.6 | 104.6 |
| Veq SF (ml) | 58.6 | 56.8 | 56.8 |

Table 6 below specifies for each tested fluorinated solvent, the partition coefficient (K_{eq}) between both phases at equilibrium, of the main tracers of the essential oil; K is defined as the ratio of the concentrations of each tracer in the fluorinated phase and in the supernatant essential oil when the biphasic system is at equilibrium. The table additionally specifies for each tracer, its initial content in the essential oil (Cᵢ) as well as its chemical family to which it belongs or its functionalization.

TABLE 6

| | Chemical family/ | Ci | | | |
|---|---|---|---|---|---|
| | functiona- | (% | K_{eq} (×10³) | | |
| | lization | m/m) | PF5060 | PF5080 | PF5052 |
| α-thujene | monoterpene | 1 | 91 | 112 | 137 |
| α-terpinene | | 1 | 46 | 54 | 73 |
| β-myrcene | | 2 | 61 | 71 | 97 |
| γ-terpinene | | 4 | 47 | 45 | 67 |
| p-cymene | | 12 | 38 | 47 | 62 |
| β- | sesquiterpene | 3 | ND | ND | 39 |
| caryophyllene | | | | | |
| linalol | monoterpenic | 2 | ND | ND | 104 |
| | alcohol | | | | |
| carvacrol | a sterically | 70 | 2 | 2 | 12 |
| | hindered phenol | | | | |
| | with a single | | | | |
| | free OH | | | | |

ND: not detected in the fluorinated phase by gas chromatography

These results show that the fluorinated solvents used are selective and they generally solubilize terpenic hydrocarbon species preferentially over species with free hydroxyl functions. In particular, it shall be noted that carvacrol is only very slightly represented in the fluorinated phase whereas it is the most dominant constituent (70%) of the essential oil.

In the case of treatment with PF5052, linalol is an exception with a higher distribution in the fluorinated phase as those for most hydrocarbons.

### EXAMPLE 4

### Fractionation of Origan Essential Oil in a Semi-Continuous Mode

Fractionation of origan essential oil in a semi-continuous mode was carried out with perfluorohexane (PF5060), with a boiling temperature at atmospheric pressure of 56° C.

The extraction is carried out in a liquid/liquid extractor operating semi-continuously. The extraction stage containing the essential oil is equipped with a jacket fed with a thermostatization fluid. The extraction stage is fed with PF5060 (perfluorohexane) from the recycling stage, distributed as droplets in the essential layer. The fluorinated phase loaded with extract, is sent back to the boiler of the recycling stage by an overflow system. The flow rate of the recycled fluorinated solvent is set by adjusting the heating power of the boiler.

40.5 g of origan essential oil were treated in this way, at 20° C. and with total volume of 7.2 liters (12.2 kg) of perfluorohexane. At the end of the extraction, the raffinate and extract were desolventized and analyzed by gas chromatography.

Table 7 below shows the mass content in the main tracers of the initial origan essential oil, of the raffinate at the end of the processing and of the obtained extract.

TABLE 7

| | | % in | | |
|---|---|---|---|---|
| | | the | | % in |
| | Chemical | initial | % in the | the |
| Main tracers | family | oil | raffinate | extract |
| α-thujene | monoterpene | 1.1 | 0.3 | 4.2 |
| α-terpinene | | 1.0 | 0.3 | 3.4 |
| β-myrcene | | 2.3 | 0.7 | 7.18 |
| γ-terpinene | | 4.1 | 1.0 | 14.8 |
| p-cymene | | 13.0 | 4.0 | 42.8 |
| β- | sesquiterpene | 3.1 | 0.7 | 11.0 |
| caryophyllene | | | | |
| linalol | monoterpenic | 2.1 | 2.6 | 0.4 |
| | alcohol | | | |
| carvacrol | a sterically | 67.1 | 86.0 | 5.3 |
| | hindered | | | |
| | phenol with a | | | |
| | single free | | | |
| | OH | | | |

The mass balance for each molecule family and for each of the recovered fractions is summarized in table 8 below.

TABLE 8

| | mass in the | mass in the | mass in the |
|---|---|---|---|
| | initial oil | raffinate | extract |
| chemical family | (g) | (g) | (g) |
| monoterpenes/ | 9.9 | 1.9 | 5.25 |
| sesquiterpenes | | | |
| monoterpenic | 0.8 | 0.7 | 0.02 |
| alcohol | | | |
| sterically | 2.7 | 2.4 | 0.33 |
| hindered phenol | | | |
| with a single | | | |
| free OH | | | |

These results show that the treatment with perfluorohexane extracts in majority non-functionalized monoterpenes and sesquiterpenes, and thereby increases the aromatic compound content in the raffinate.

The obtained raffinate is therefore enriched in carvacrol to 86% versus 67% in the starting essential oil by extraction of 80% of the terpenic hydrocarbons

1. A method for fractionating essential oils or fractions of essential oils, characterized in that it comprises a step consisting of contacting said essential oils with an extracting agent containing at least one fluorinated solvent in order to obtain a fluorinated phase and a non-fluorinated phase and a step for separating the fractions of essential oils contained in said fluorinated phase and in said non-fluorinated phase, and in that said fluorinated solvent is selected from:
aliphatic perfluoroalkanes with general formula CₙF₂ₙ₊₂ with 5≦n≦15;
perfluoroalkanes having a cyclic unit, with general formula CₙF₂ₙ with 5≦n≦15;
perfluoroalkanes having two cyclic units, with general formula CₙF₂ₙ₋₂ with 8≦n≦15; or is
perfluoro-N-methylmorpholine with formula C₅ONF₁₁.

2. The method according to claim 1, characterized in that said extracting agent comprises at least one organic co-solvent.

3. The method according to any of claims 1 or 2, characterized in that it is conducted in at least one heated and thermostatized enclosure at a pre-determined temperature.

4. The method according to any of claims 1 to 3, characterized in that said separation step is carried out by evaporation.

5. The method according to claim 4, characterized in that said evaporation is carried under reduced pressure.

6. The method according to any of claims 1 to 5, characterized in that it comprises a recycling step of said fluorinated solvent.

7. The method according to claims 3 and 6, characterized in that said recycled fluorinated solvent is brought to said predetermined temperature.

8. The method according to any of claims 3 to 7, characterized in that said liquid phase and/or said non-fluorinated phase are cooled before proceeding with the separation of the fraction(s) of essential oils which they contain.

9. The method according to any of claims 1 to 8, characterized in that it comprises a step for desolventizing the obtained fractions of essential oils.

10. The method according to any of claims 1 to 9, characterized in that it comprises a step consisting of inertizing said fluorinated solvent.

11. The method according to any of claims 1 to 10, characterized in that it consists of placing said essential oil in a heated and thermostatized enclosure, distributing said extracting agent containing said fluorinated solvent as droplets in the essential oil, collecting said fluorinated phase in the lower portion of said enclosure.
